(19) United States
(12) Patent Application Publication
(10) Pub. No.: US 2002/0183009 A1
(43) Pub. Date: Dec. 5, 2002

(54) Radio communication within a computer system

(76) Inventors: Jose M. Cruz-Albrecht, Palo Alto, CA (US); Hans Eberle, Mountain View, CA (US); Neil C. Wilhelm, Menlo Park, CA (US)

Correspondence Address: PARK, VAUGHAN & FLEMING LLP, 508 SECOND STREET, SUITE 201, DAVIS, CA, 95616, US

(21) Appl. No.: 09/873,146

(22) Filed: Jun. 1, 2001

(51) Int. Cl. H04B 7/00

(52) U.S. Cl. 455/66; 455/557; 455/558

(57) ABSTRACT

One embodiment of the present invention provides a system that facilitates communicating between integrated circuit devices within a computing system. The system includes integrated circuit devices with an individual radio port coupled to each integrated circuit device. Each radio port includes a transmitting mechanism that is configured to generate radio signals in response to commands from the integrated circuit device. An antenna is coupled to the radio port to transmit the radio signal generated by the transmitting mechanism and to detect a response to the radio signal. Each radio port also includes a receiving mechanism to receive responses from the antenna and pass the responses to the integrated circuit device.

### BACKGROUND

1. Field of the Invention

The present invention relates to integrated circuit devices. More specifically, the present invention relates to an apparatus and a method for communicating with an integrated circuit device in order to establish control over the integrated circuit device and to exchange data with the integrated circuit device.

2. Related Art

Modem computing systems can include many integrated circuit devices distributed among multiple circuit boards and multiple subsystems. These integrated circuit devices are typically coupled together by buses for communicating instructions and data. For example, instructions may be delivered to a central processing unit from a memory device using a bus, and the central processing unit may receive data from or send data to the memory device or an input/output device using a bus.

Additionally, buses may be used to send commands to an integrated circuit device or to receive replies from the integrated circuit device. These commands may include initialization commands, configuration commands, report status commands, and parameter monitoring commands. The replies may include initialization complete, current configuration, current status, and parameter out-of-tolerance responses.

The integrated circuit devices may also be able to communicate with a test device using boundary-scan techniques such as Joint Test Action Group (JTAG) or IEEE Std. 1149.1 interfaces. Boundary-scan allows an engineer or technician to determine the status of the integrated circuit devices and to change the status of the integrated circuit devices independent of the normal bus structure of a computing system.

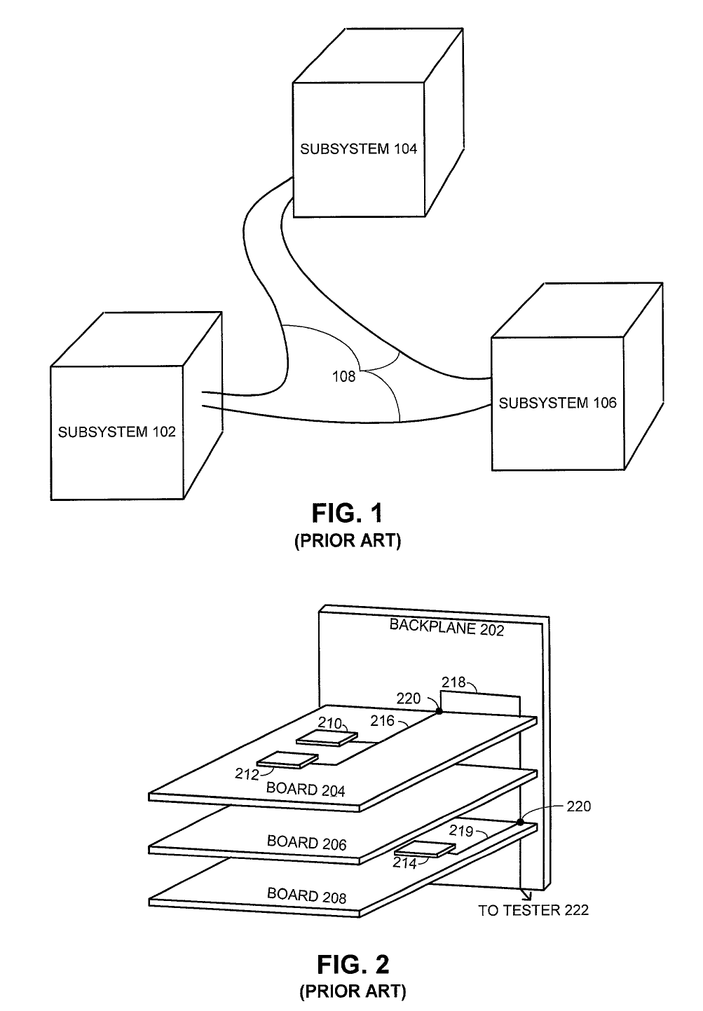

Examples of how the various devices, circuit boards, and subsystems are coupled together are illustrated in FIGS. 1, 2, 3A, and 3B, which are discussed below.

FIG. 1 illustrates computer subsystems coupled together using physical conductors. Computer subsystems 102, 104, and 106 are separate components of a computer system and may be located several meters apart. Computer subsystems 102, 104, and 106 are coupled together by physical channels 108. Physical channels 108 may include copper wires and fiber-optic channels.

FIG. 2 illustrates printed circuit boards coupled to a backplane within a computer subsystem. Circuit boards 204, 206, and 208 are coupled to backplane 202. Circuit traces 216, and 218 located on circuit board 204 and backplane 202, respectively, include multiple traces typical of a bus structure and may include traces for a JTAG interface. These circuit traces are coupled between circuit boards 204, 206, and 208 and backplane 202 through connectors 220. Circuit traces 218 may additionally be coupled off of backplane 202 to a system controller or a tester, such as a JTAG tester, through tester interface 222.

Integrated circuit devices 210 and 212 on circuit board 204 and integrated circuit device 214 on circuit board 208 are coupled together through circuit traces 216, 218, and 219. One of these integrated circuit devices may be a master device, which controls the other integrated circuit devices. For example, integrated circuit device 214 may be a central processing unit while integrated circuit devices 210 and 212 may include memory devices and input/output devices.

3A illustrates a typical central processing unit circuit board 302 within a computer subsystem. Central processing unit circuit board 302 includes central processing unit 304, SRAMs 308 and 310, DRAMs 312, 314, and 316, and bridge chip 306 coupled together by buses 318.

Central processing unit 304 controls the operation of the computer subsystem. SRAMs 308 and 310 form a cache for central processing unit 304 so that central processing unit 304 can read instructions and can read and write data in these faster devices. DRAMs 312, 314, and 316 form the main memory for the computer subsystem, and may include an error-correcting code (ECC). Bridge chip 306 couples the internal bus 318 to external bus 320.

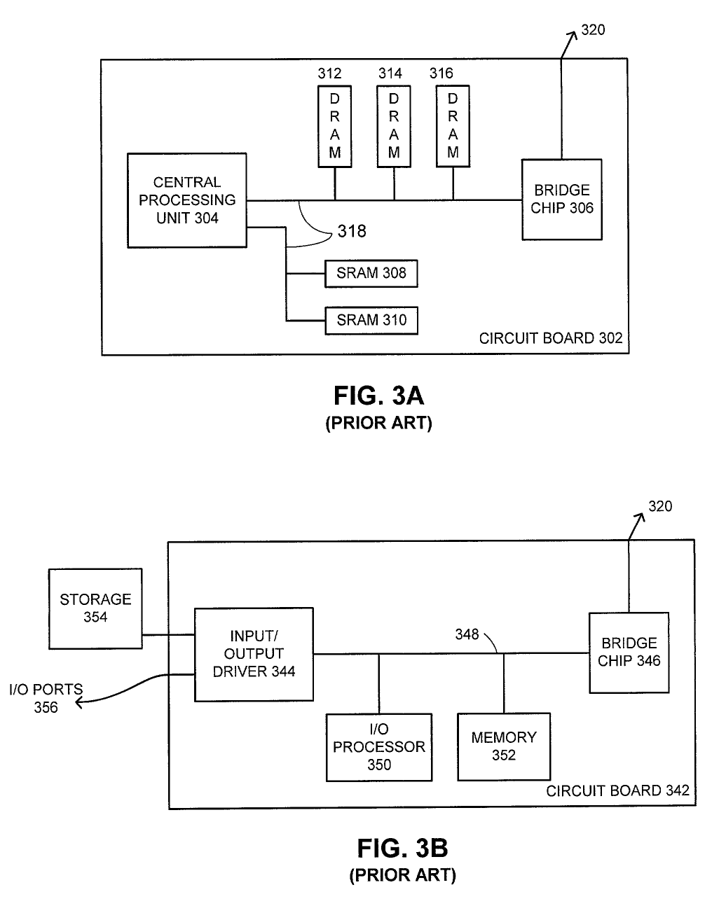

In the computer subsystem shown in FIG. 3A, all communication between central processing unit 304 and the other devices on circuit board 302 is across buses 318. This includes initialization commands, configuration commands, status commands and reports, and parameter violation reports such as ECC errors.

FIG. 3B illustrates a typical input/output circuit board 342 within a computer subsystem. Input/output circuit board 342 includes input/output driver 344, input/output processor 350, memory 352, and bridge chip 346 coupled together by bus 348. Input/output processor 350 controls the input and output from the computer subsystem. Input/output processor 350 uses memory 352 as temporary storage for data entering and leaving the computer subsystem. Bridge chip 346 couples the internal bus 348 to external bus 320.

Input/output driver 344 functions as the interface between internal bus 348 and external devices such as storage 354 and input/output ports 356. Storage 354 can include any type of non-volatile storage device that can be coupled to a computer system. This includes, but is not limited to, magnetic, optical, and magneto-optical storage devices, as well as storage devices based on flash memory and/or battery-backed up memory. Input/output ports 356 can include couplings to an RS-232 device, a SCSI bus, and an Ethernet.

All communications, including initialization commands, configuration commands, status commands and reports, and parameter violation reports, between central processing unit 304 on circuit board 302 and the devices on input/output circuit board 342 use internal buses 318 and 348 and external bus 320.

Using internal buses 318 and 348 and external bus 320 for initialization commands, configuration commands, status commands and reports, and parameter violation reports uses bus bandwidth, thereby interfering with other necessary communications. More importantly, it complicates bus protocols since they have to accommodate out-of-band signaling in addition to regular data transfers. Also, bootstrapping is complicated if the bus is needed to communicate bus configuration parameters. Additionally, a failure on any of these buses can prevent communication of commands and reports, which makes troubleshooting difficult. Use of an external test device can also interfere with the operation of the computer subsystem by preempting communication channels and using bus bandwidth.

What is needed is an apparatus and a method, which allows communication between central processing unit 304, a test device, and the other integrated circuit devices within the computer subsystem, that does not use bus bandwidth and operates even when there are failures on the buses.

### SUMMARY

One embodiment of the present invention provides a system that facilitates communicating information used for initialization, identification, configuration, self-test reports, and error reports between integrated circuit devices within a computing system. These types of information require only low data rates that are provided by radio links, which are orthogonal to the higher speed physical interconnect. The system includes integrated circuit devices with an individual radio port coupled to each integrated circuit device. Each radio port includes a transmitting mechanism that is configured to generate radio signals in response to commands from the integrated circuit device. An antenna is coupled to the radio port to transmit the radio signal generated by the transmitting mechanism and to detect a response to the radio signal. Each radio port also includes a receiving mechanism to receive commands and responses from the antenna and pass the commands and responses to the integrated circuit device.

In one embodiment of the present invention, communication with the integrated circuit device includes communication of boundary-scan data, initialization information, identification information, configuration information, results of self-tests, and error reports.

In one embodiment of the present invention, the radio port is implemented in a separate integrated circuit device.

In one embodiment of the present invention, the radio port is incorporated into the integrated circuit device.

In one embodiment of the present invention, the radio port receives operating power from the integrated circuit device's power supply.

In one embodiment of the present invention, the radio port receives operating power from a battery.

In one embodiment of the present invention, the radio port receives operating power from radio waves received on the antenna.

In one embodiment of the present invention, the antenna is incorporated into the integrated circuit device.

In one embodiment of the present invention, the antenna is a trace on a printed-wire board.

In one embodiment of the present invention, the antenna is a separate wire.

In one embodiment of the present invention, the radio port includes a collision detection mechanism that is configured to detect a collision when more than one response is received simultaneously.

In one embodiment of the present invention, the radio port includes a collision recovery mechanism that is configured to resolve collisions when multiple signals are received simultaneously.

### BRIEF DESCRIPTION OF THE FIGS.

FIG. 1 illustrates computer subsystems coupled together using physical conductors.

FIG. 2 illustrates printed circuit boards coupled to a backplane within a computer subsystem.

FIG. 3A illustrates a typical central processing unit circuit board 302 within a computer subsystem.

FIG. 3B illustrates a typical input/output circuit board 342 within a computer subsystem.

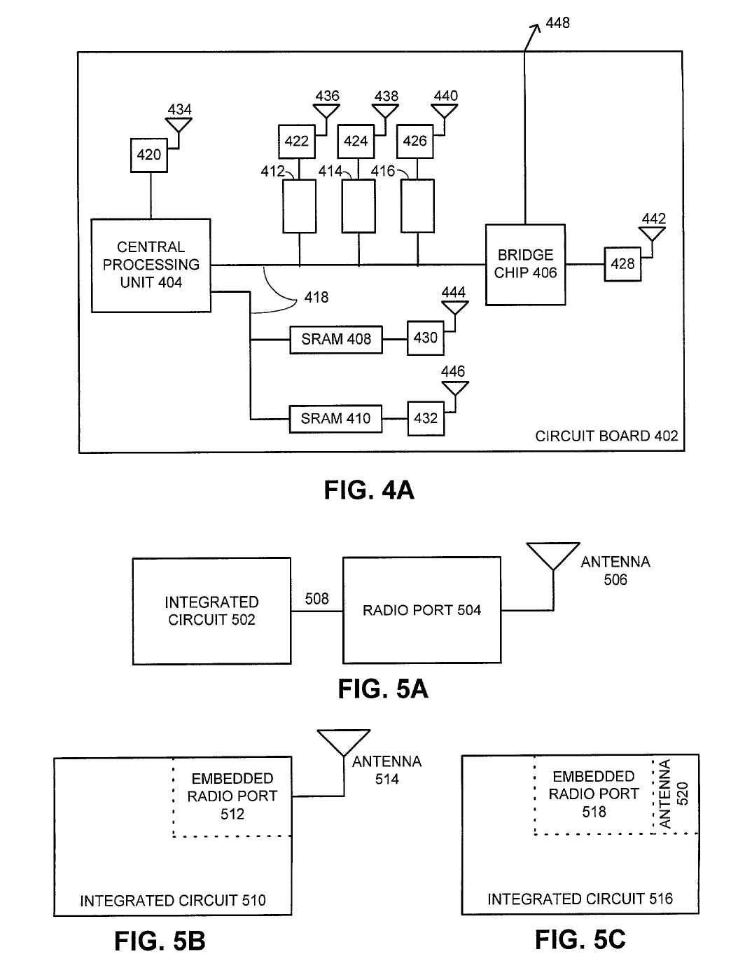

FIG. 4A illustrates central processing unit circuit board 402 in accordance with an embodiment of the present invention.

FIG. 4B illustrates central processing unit circuit board 402 including system controller 450 in accordance with an embodiment of the present invention.

FIG. 5A illustrates integrated circuit 502 coupled to external radio port 504 in accordance with an embodiment of the present invention.

FIG. 5B illustrates integrated circuit 510 with embedded radio port 512 in accordance with an embodiment of the present invention.

FIG. 5C illustrates integrated circuit 516 with embedded radio port 518 and embedded antenna 520 in accordance with an embodiment of the present invention.

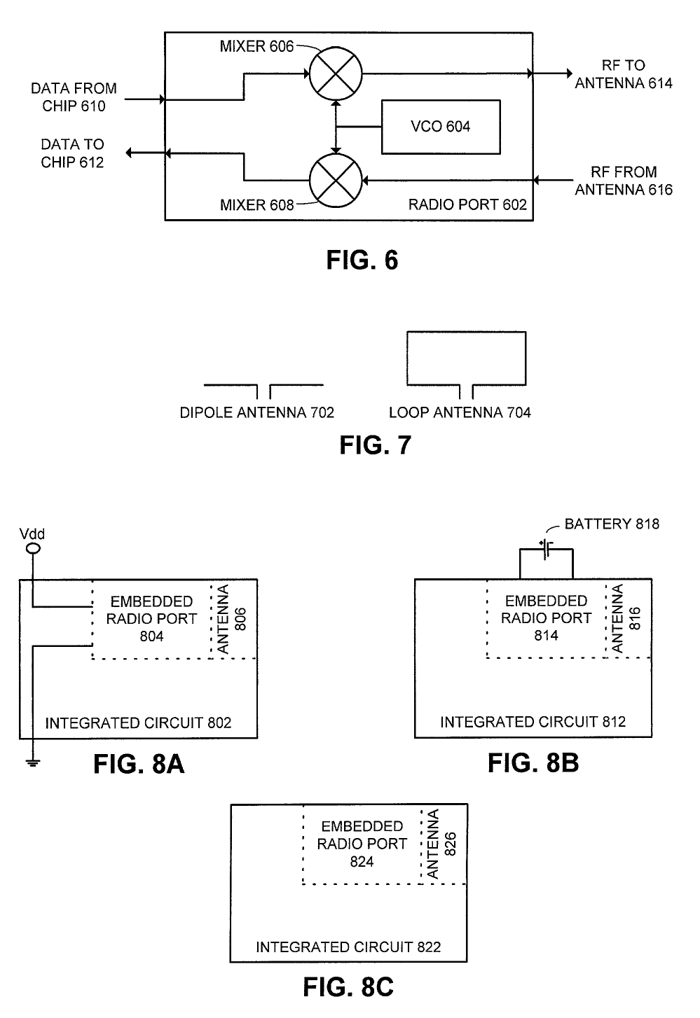

FIG. 6 illustrates typical radio port 602 in accordance with an embodiment of the present invention.

FIG. 7 illustrates antenna structures in accordance with an embodiment of the present invention.

FIG. 8A illustrates supplying power to integrated circuit 802 in accordance with an embodiment of the present invention.

FIG. 8B illustrates supplying power to integrated circuit 812 in accordance with an embodiment of the present invention.

FIG. 8C illustrates supplying power to integrated circuit 822 in accordance with an embodiment of the present invention.

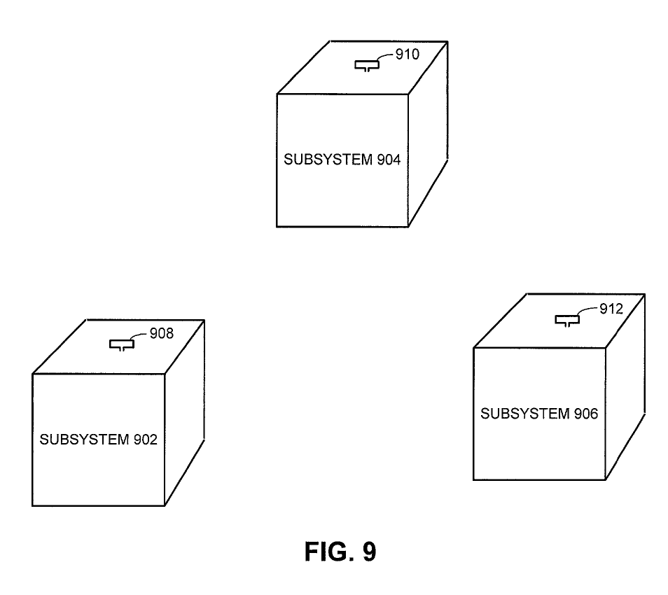

FIG. 9 illustrates computer subsystems coupled together in accordance with an embodiment of the present invention.

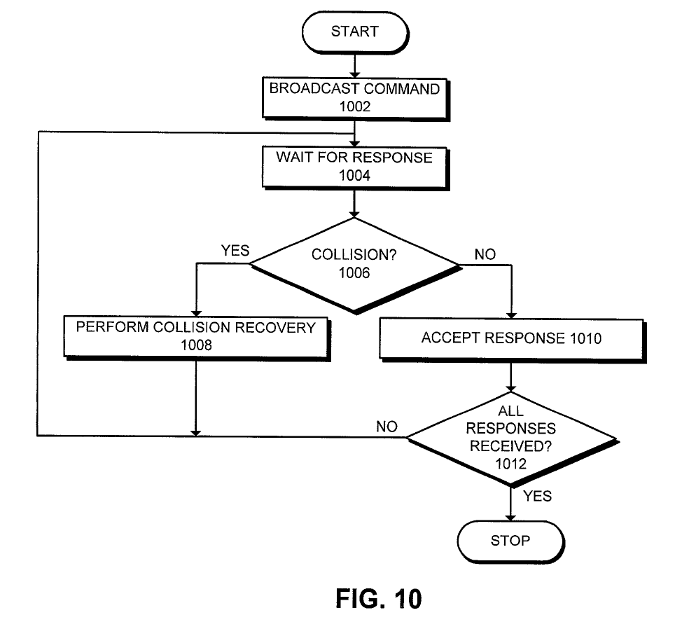

FIG. 10 is a flowchart illustrating the process of a system controller or a central processing unit communicating via radio link with integrated circuit devices in accordance with an embodiment of the present invention.

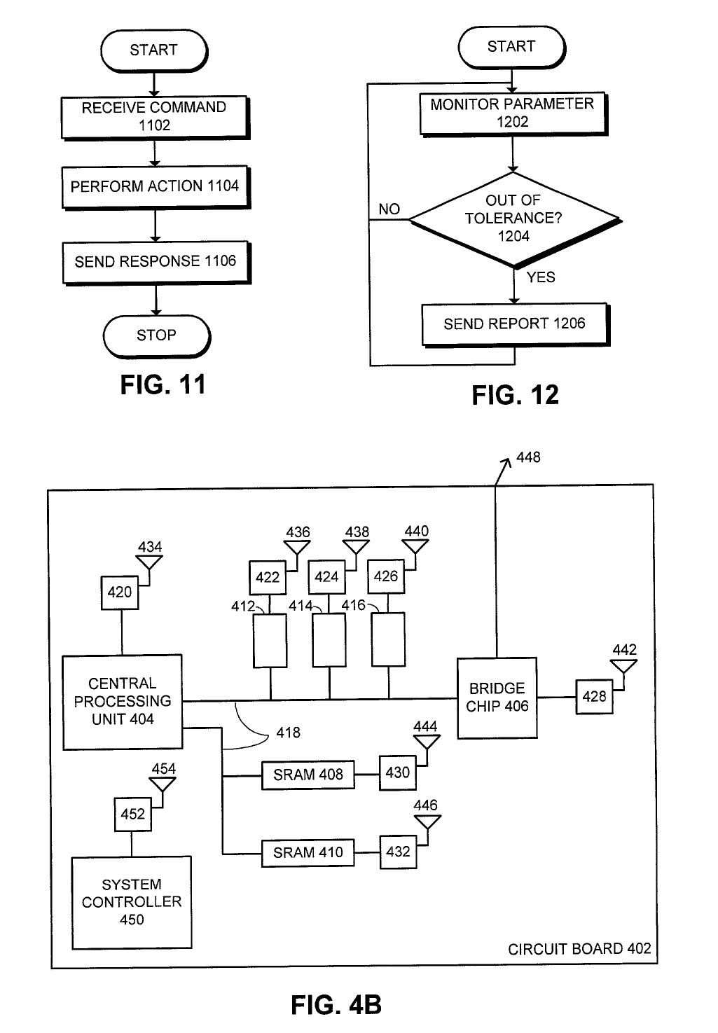

FIG. 11 is a flowchart illustrating the process of an integrated circuit responding to commands in accordance with an embodiment of the present invention.

FIG. 12 is a flowchart illustrating the process of an integrated circuit monitoring a parameter and reporting an out-of-tolerance condition in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Circuit Board with Radio Communications

FIG. 4A illustrates central processing unit circuit board 402 in accordance with an embodiment of the present invention. Central processing unit circuit board 402 includes central processing unit 404, SRAMs 408 and 410, DRAMs 412, 414, and 416, and bridge chip 406 coupled together by buses 418.

Central processing unit 404 controls the operation of the computer subsystem. SRAMs 408 and 410 form a cache for central processing unit 404 so that central processing unit 404 can read instructions and can read and write data in these faster devices. DRAMs 412, 414, and 416 form the main memory for the computer subsystem, and may include an error-correcting code (ECC). Bridge chip 406 couples the internal bus 418 to external bus 448.

Central processing unit circuit board 402 also includes radio ports 420, 422, 424, 426, 428, 430, and 432 coupled to central processing unit 404, DRAMs 412, 414, and 416, bridge chip 406, and SRAMs 408 and 410 respectively. Radio ports 420, 422, 424, 426, 428, 430, and 432 are, in turn, coupled to antennas 434, 436, 438, 440, 442, 444, and 446.

Since radio port 420 is coupled to central processing unit 404, radio port 420 may be the master radio port, which communicates with radio ports 422, 424, 426, 428, 430, and 432 to send command messages and data to these radio ports and to receive command responses and status data from these radio ports. Antennas 434, 436, 438, 440, 442, 444, and 446 send and receive radio frequency (RF) signals for their respective radio ports.

Alternatively, as shown in FIG. 4B, master radio port 452 is coupled to system controller 450. Master radio port 452 and system controller 450 can be located on the same board, on a different board, or in a nearby subsystem.

In operation, master radio port 420 can send a broadcast or multi-cast signal to all, or a select group, of radio ports for processing by the integrated circuit device coupled to the individual radio port. When one of these ports replies to the broadcast signal, master radio port 420 receives the signal and passes the response to central processing unit 404. Commands sent from central processing unit 404 through radio port 420 and antenna 434 include, but are not limited to, identification commands, initialization commands, configuration commands, status report commands, and monitor parameter commands. Responses received include, but are not limited to identification information, initialization complete, configuration complete, current configuration, current status, parameter out-of-range, and error reports.

Radio ports coupled to other integrated circuit devices, for example radio port 428 coupled to bridge chip 406, receive the commands from central processing unit 404 through antenna 442 and pass the received command to the integrated circuit device coupled to the radio port, bridge chip 406 in this example. Bridge chip 406 then implements the command and returns any necessary reply through radio port 428.

Radio ports 420, 422, 424, 426, 428, 430, and 432 can also communicate with an external test device such as a JTAG test device (not shown). Communication between the various radio ports does not interrupt normal communication on buses 418, therefore, central processing unit 404 or an external test device can communicate with the integrated circuits without interrupting normal processing of the computer.

Responses from radio ports 422, 424, 426, 428, 430, and 432 to central processing unit 404 or an external test device may need some sort of collision avoidance or collision resolution protocol. For example, central processing unit 404 could poll the other integrated circuit devices for responses, or the system could implement a protocol such as the well known ALOHA protocol. In general, any available collision avoidance/collision resolution mechanism can be used.

Radio Ports and Antennas

FIG. 5A illustrates integrated circuit 502 coupled to external radio port 504 in accordance with an embodiment of the present invention. Integrated circuit 502 is any integrated circuit that has internal circuitry for communicating commands and status. For example, devices that implement boundary-scan techniques, self-test, power and temperature sensing, chip identification, and configuration. Integrated circuit 502 is coupled to radio port 504 across circuit traces 508. Radio port 504 is coupled to antenna 506 for transmission and reception of RF signals. Data passed from integrated circuit 502 to radio port 504 modulates an RF carrier wave in radio port 504. The modulated carrier wave is transmitted by antenna 506.

Antenna 506 receives modulated carrier waves from other integrated circuits and passes these carrier waves to radio port 504. Radio port 504 demodulates these carrier waves and supplies the received data to integrated circuit 502.

FIG. 5B illustrates integrated circuit 510 with embedded radio port 512 in accordance with an embodiment of the present invention. In this implementation, radio port 512 is embedded within integrated circuit 510. Antenna 514 is external to integrated circuit 510. Operation of this circuit is equivalent to the circuit of FIG. 5A and will not be described further.

FIG. 5C illustrates integrated circuit 516 with embedded radio port 518 and embedded antenna 520 in accordance with an embodiment of the present invention. In this implementation, both radio port 518 and antenna 520 are embedded within integrated circuit 516. Operation of this circuit is also equivalent to the circuit of FIG. 5A and will not be described further. Radio Port

FIG. 6 illustrates typical radio port 602 in accordance with an embodiment of the present invention. Radio port 602 includes voltage controlled oscillator (VCO) 604, and mixers 606 and 608. VCO 604 generates an RF carrier wave at a suitable frequency, for example 2.4 GHz. The RF carrier wave is coupled to mixers 606 and 608.

Data from chip 610 is also coupled to mixer 606. Mixer 606 modulates the RF carrier wave with data from chip 610. The modulated RF carrier wave is coupled out of radio port 602 as RF to antenna 614, where it is transmitted from an antenna (not shown).

Signals received on the antenna are coupled to radio port 602 as RF from antenna 616. RF from antenna 616 is coupled to mixer 608. Mixer 608 demodulates RF from antenna 616 to recover the data modulated on RF from antenna 616. The recovered data is coupled from radio port 602 as data to chip 612.

Antennas

FIG. 7 illustrates antenna structures in accordance with an embodiment of the present invention. Dipole antenna 702 requires little space and can be implemented as traces on a circuit board or within an integrated circuit's package. Loop antenna 704 is another possible antenna structure that can be used. Many other antenna structures are suitable for transmitting and receiving signals in this application as will be obvious to a practitioner with ordinary skill in the art.

Power Sources

FIG. 8A illustrates supplying power to integrated circuit 802 in accordance with an embodiment of the present invention. In this implementation, embedded radio port 804 within integrated circuit 802 receives power from the Vdd supplied from a system power source (not shown) to integrated circuit 802. Failure of integrated circuit 802 to receive power also results in failure of embedded radio port 804 to receive power. Embedded radio port 804 can delay power failure by storing power in a capacitor. This allows radio port 804 to transmit and receive radio signals for a limited period of time after system power has failed.

FIG. 8B illustrates supplying power to integrated circuit 812 in accordance with an embodiment of the present invention. In this implementation, embedded radio port 814 receives power from battery 818 independent of the power supplied to integrated circuit 812. Using the separate power source for embedded radio port 814 allows the radio port to be active and able to report status even when integrated circuit 812 is not powered.

FIG. 8C illustrates supplying power to integrated circuit 822 in accordance with an embodiment of the present invention. In this implementation, embedded radio port 824 receives power from the RF received by antenna 826. Using received RF as a power source for embedded radio port 824 allows radio port 824 to be active and able to report status even when integrated circuit 822 is not powered. In addition, using received RF power to power radio port 824 removes the requirement for battery 818 and related components.

Computer Subsystems

FIG. 9 illustrates computer subsystems coupled together in accordance with an embodiment of the present invention. Subsystems 902, 904, and 906 include antennas 908, 910, and 912 respectively. Commands and data are communicated among subsystems 902, 904, and 906 using radio signals in a manner similar to the way commands and data are communicated among integrated circuits as described above. Note that using RF to communicate information used for initialization, identification, configuration, self-test results, and error reports does not eliminate the requirement for physical couplings among subsystems 902, 904, and 906 to carry regular CPU instructions and high speed data.

Commands and Responses

FIG. 10 is a flowchart illustrating the process of a system controller or a central processing unit communicating via radio link with integrated circuit devices in accordance with an embodiment of the present invention. The system starts when a master radio port, say radio port 420 (see FIG. 4), is directed by central processing unit 404 to broadcast a command (step 1002). This command may include, but is not limited to, an initialization command, a configuration command, a status report command, and a monitor parameter command. Radio ports 422, 424, 426, 428, 430, and 432 receive the command and pass the command to integrated circuits 412, 414, 416, 428, 408, and 410 respectively.

Next, radio port 420 waits for a response from integrated circuits 412, 414, 416, 428, 408, and 410 (step 1004). When a response is received, radio port 420 determines if there has been a collision between responses from two or more integrated circuits (step 1006). This discussion assumes that a collision resolution protocol has been implemented. There are many well-known collision resolution protocols in existence such as the ALOHA protocol that can be used. Note that is possible to avoid the possibility of a collision using other techniques such as polling integrated circuits 412, 414, 416, 428, 408, and 410 for responses.

If a collision is detected at 1006, radio port 420 performs the collision recovery protocol being used (step 1008). Control then returns to 1004 to wait for more responses.

If no collision is detected at 1006, radio port 420 accepts the response and supplies the response to central processing unit 404 (step 1010). Next, radio port 420 determines if all responses have been received (step 1012). If all responses have not been received, control returns to 1004 to wait for more responses, otherwise, the process is complete.

Processing a Command

FIG. 11 is a flowchart illustrating the process of an integrated circuit responding to commands in accordance with an embodiment of the present invention. The system starts when a radio port, say radio port 428 (see FIG. 4), receives a command broadcast by a master radio port (step 1102). Radio port 428 passes the command to bridge chip 406 for action (step 1104). After performing the action, bridge chip 406 can pass a response to radio port 428 for transmission back to the master radio port ending the process (step 1106).

Monitoring a Parameter

FIG. 12 is a flowchart illustrating the process of an integrated circuit monitoring a parameter and reporting an out-of-tolerance condition in accordance with an embodiment of the present invention. The system starts when an integrated circuit, say bridge chip 406 (see FIG. 4), receives a command to monitor a parameter (step 1202). The parameter may include, but is not limited to, voltage, current, and temperature. Bridge chip 406 monitors the parameter for an out-of-tolerance condition (step 1204). If the parameter is out of tolerance, bridge chip 406 reports the condition to the master radio port using radio port 428 and antenna 422 (step 1206). After sending the report at 1206 or if the parameter is not out of tolerance at 1204, the system returns to 1202 to continue monitoring the parameter.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus that facilitates communication with an integrated circuit device within a computing system, comprising:
the integrated circuit device;
a radio port coupled to the integrated circuit device, wherein the radio port includes a transmitting mechanism that is configured to generate a radio signal in response to a command from the integrated circuit device;
an antenna coupled to the radio port, wherein the antenna is configured to transmit the radio signal generated by the transmitting mechanism, and wherein the antenna is additionally configured to detect a response to the radio signal; and
wherein the radio port further includes a receiving mechanism, wherein the receiving mechanism is configured to receive the response from the antenna and pass the response to the integrated circuit device.

2. The apparatus of claim 1, wherein communication with the integrated circuit device includes communication of one of, boundary-scan data, initialization information, identification information, configuration information, results of self-tests, and error reports.

3. The apparatus of claim 1, wherein the radio port is implemented in a separate integrated circuit device.

4. The apparatus of claim 1, wherein the radio port is incorporated into the integrated circuit device.

5. The apparatus of claim 4, wherein the radio port receives operating power from the integrated circuit device's power supply.

6. The apparatus of claim 4, wherein the radio port receives operating power from a battery.

7. The apparatus of claim 4, wherein the radio port receives operating power from radio waves received on the antenna.

8. The apparatus of claim 4, wherein the antenna is incorporated into the integrated circuit device.

9. The apparatus of claim 4, wherein the antenna is a trace on a printed-wire board.

10. The apparatus of claim 4, wherein the antenna is a separate wire.

11. The apparatus of claim 1, wherein the radio port includes a collision detection mechanism that is configured to detect a collision when more than one response is received simultaneously.

12. The apparatus of claim 11, wherein the radio port includes a collision recovery mechanism that is configured to resolve collisions when more than one response is received simultaneously.

13. An apparatus that facilitates communication with an integrated circuit device within a computing system, comprising:
the integrated circuit device;
a radio port coupled to the integrated circuit device;
an antenna coupled to the radio port;
wherein the antenna is configured to detect a radio signal and pass the radio signal to the radio port;
wherein the radio port includes a receiving mechanism that is configured to receive the radio signal from the antenna;
wherein the radio port includes a passing mechanism that is configured to pass control commands to the integrated circuit device in response to the radio signal; and
wherein the radio port further includes a transmitting mechanism that is configured to transmit a response to the radio signal that is generated by the integrated circuit device.

14. The apparatus of claim 13, wherein communication with the integrated circuit device includes communication and monitoring of boundary-scan data, self test data, power and temperature data, chip identification data, and configuration data.

15. The apparatus of claim 13, wherein the radio port is incorporated into the integrated circuit device.

16. The apparatus of claim 15, wherein the radio port receives operating power from the integrated circuit device's power supply.

17. The apparatus of claim 15, wherein the radio port receives operating power from a battery.

18. The apparatus of claim 15, wherein the radio port receives operating power from radio waves received on the antenna.

19. The apparatus of claim 15, wherein the antenna is incorporated into the integrated circuit device.

20. A system that facilitates communication between a test device and a plurality of integrated circuit devices within a computing system, comprising:
the test device;
the plurality of integrated circuit devices;
a radio transmitter at the test device for transmitting a command from the test device to the plurality of integrated circuit devices; and
a radio receiver at the test device to receive a response from each integrated circuit device of the plurality of integrated circuit devices.

21. The system of claim 20, wherein communication with the plurality of integrated circuit devices includes communication of boundary-scan data.

22. The system of claim 20, wherein the command from the test device includes one of, an initialization command, a configuration command, and a report status command.

23. The system of claim 20, wherein the response from each integrated circuit device includes one of, a success response, a failed response, and a status message.

24. The system of claim 20, wherein the radio receiver includes a collision detection mechanism configured to detect collisions between multiple simultaneous responses from the plurality of integrated circuit devices.

25. The system of claim 24, wherein the radio receiver includes a collision resolution mechanism configured to resolve collisions between multiple simultaneous responses from the plurality of integrated circuit devices.

26. A method for communicating among a plurality of integrated circuit devices within a computing system, comprising:
broadcasting a command from a radio port coupled to a control device, wherein the control device is one of, a testing device, a system controller, a central processing unit, and a first integrated circuit device within the plurality of integrated circuit devices;
receiving the command at a second integrated circuit device within the plurality of integrated circuit devices;
transmitting a response to the command from the second integrated circuit device; and
receiving the response at the control device.

27. The method of claim 26, wherein communication among the plurality of integrated circuit devices includes communication of boundary-scan data.

28. The method of claim 26, wherein the command includes one of, an initialization command, a configuration command, and a report status command.

29. The method of claim 26, further comprising:
detecting a collision between simultaneous responses from the plurality of integrated circuit devices; and
resolving the collision between simultaneous responses from the plurality of integrated circuit devices.

30. The method of claim 26, wherein communicating among the plurality of integrated circuit devices within the computing system includes using one of, multiple radio channels, spread spectrum radio communications, and polling from the control device to avoid collisions.

31. The method of claim 26, further comprising acting on the command at the second integrated circuit device.

32. An apparatus that facilitates communication with an integrated circuit device within a computing subsystem within a computing system, wherein the computing subsystem is separated from other computing subsystems within the computing system, comprising:
the computing subsystem including the integrated circuit device;
a radio port coupled to the integrated circuit device, wherein the radio port includes a transmitting mechanism that is configured to generate a radio signal in response to a command from the integrated circuit device;
an antenna coupled to the radio port external to the computing subsystem, wherein the antenna is configured to transmit the radio signal generated by the transmitting mechanism, and wherein the antenna is additionally configured to detect a response to the radio signal; and
wherein the radio port further includes a receiving mechanism, wherein the receiving mechanism is configured to receive the response from the antenna and pass the response to the integrated circuit device.
